(19) United States
(12) Patent Application Publication
(10) Pub. No.: US 2018/0086497 A1
(43) Pub. Date: Mar. 29, 2018

(54) BOX LINER PULL OUT INSERTS

(71) Applicants: Steve Kohn, Short Hills, NJ (US); Luis DeOliveira, Lanoka Harbor, NJ (US); Steve Guerra, Ambler, PA (US)

(72) Inventors: Steve Kohn, Short Hills, NJ (US); Luis DeOliveira, Lanoka Harbor, NJ (US); Steve Guerra, Ambler, PA (US)

(21) Appl. No.: 15/280,036

(22) Filed: Sep. 29, 2016

(51) Int. Cl. B65D 5/56; A01K 1/01; B65D 5/02; B65D 5/42; B65D 5/46; A45C 3/00; B65F 1/00; B65F 1/14; B65D 81/28; A47G 11/00; A47G 9/06; A01G 25/00; B60R 13/01

(52) U.S. Cl. CPC B65D 5/566; A01K 1/0107; B65D 5/02; B65D 5/4212; B65D 5/46008; A45C 3/001; A01G 2025/003; B65F 1/14; B65D 81/28; A47G 11/003; A47G 9/062; A01G 25/00; B60R 13/01; B65F 1/0006

(57) ABSTRACT

A liner for a box or bin comprising: a flexible, semi-rigid or rigid liner, inserted into a bottom of an appropriate sized box or bin. The liner conforms to the bottom of the box or bin and becomes the base for all of contents of the box or bin. The liner has at least two handles.

### RELATED APPLICATIONS

This application claims priority to provisional application Ser. No. 62/284,671 filed Oct. 6, 2015.

### FIELD OF THE INVENTION

The present invention relates to a flexible, semi-rigid or rigid insert placed at the bottom of an appropriate sized box or bin.

### BACKGROUND OF THE INVENTION

US patent Pub 2011/0017762 relates to a container including smoking articles also including a cup shaped box for the smoking articles. The cup shaped box includes a bottom wall, side walls and an opening. The container further includes a lifting element correlated to at least one smoking article for lifting the smoking article off the bottom wall of the container. The lifting element has an engaging portion, engageable with the outside upper end portion of the smoking article.

US patent Pub 2012/0243808 relates to an insulated shipping liner that includes a flexible sealed sack having a first layer and second layer sealed together about their outer edges to form a housing. An insulating made from a single sheet of foam material is located within the housing and is folded such that a first side portion, second side portion and middle portion create a rectangular box form with the side portion defining sides of the box and the middle portion defining a bottom of the box, the rectangular top flap defines a top of the box. The box can be placed in a container to form an insulated container for shipping and storage.

U.S. Pat. No. 8,387,568 relates to a litter box liner having handle ties and a form fitted bottom. The bottom may be square or rectangular shaped and may be sized to fit into a particular size litter box. The bottom may include the feature that there are no foldovers contained therein. At least a bottom portion of the litter box liner may be reinforced to resist tears. Such a reinforcement layer may include a woven polypropylene fabric layer or an extruded polypropylene film. The litter box liner may be, at least in part, formed of high density polyethylene, providing an additional means for tear resistance in the litter box liner.

U.S. Pat. No. 7,905,388 relates to a container with a ribbon, a lid, a container base including a ribbon channel and ribbon feedthroughs, a covering floor panel, a ribbon disposed within the channel and extending through the feedthroughs, a tissue paper liner with a flap affixed between the container base and the floor panel where the tissue paper covers an item in the box and the ribbon is tied over the tissue paper.

U.S. Pat. No. 4,986,420 relates to a package having a handle for housing granular or similar products. The handle is a substantially flat strap handle. The handle is inserted into two opposing openings in the side wall of the package. A section of the side wall adjacent each of the apertures includes a liner which separates the granular contents of the package from the area surrounding the aperture. The liner prevents the flow of granular contents out through the aperture. The package can be formed from a sleeve.

U.S. Pat. No. 4,978,028 relates to a disposable container for handling biohazardous waste material that includes a rectangular six sided exterior box, a polyethylene liner within the box, a rectangular four sided interior insert positioned within the liner and a rectangular inner box positioned within the interior insert. The exterior box includes two top flaps and two lid sections each of which is integral with and in a hinged relationship with one of the sides of the exterior box. The top two flaps and lid sections form a closure at the top of the exterior box. One of the top flaps includes an access hole for dropping waste material into the disposable container. The interior includes end flaps at top and bottom of each of the sides integral with and in hinged relation with each of the sides of interior insert to maintain interior insert in a stable and equidistant relationship with respect to each of sides of exterior box. Inner box bottom includes center beam positioned normal to top and bottom of inner box bottom and parallel to each of sides of inner box bottom.

U.S. Pat. No. 4,739,882 relates to a transportable container for storing articles and maintaining a clean article, such as semiconductor wafers, clean. The container provides a box which defines an interior space. The box includes a box top and base which supports the box top and includes a door. The box door provides a region for supporting the articles in the interior space. A liner is insertable into the interior space and surrounds the region. The box door is retractable from the box space.

U.S. Pat. No. 4,615,300 relates to a litter box liner that includes a plurality of removable layers stacked one inside of the other and conformable to the shape of the interior surface of a litter box. The liner includes an imperforate bottom layer and a plurality of screening layers positioned above the bottom layer. Each screening layer includes a bottom wall with a plurality of openings therethrough which are large enough to pass granular litter but small enough to block animal excrement. The screening layer also includes an imperforate flap attached beneath the bottom wall by a flexible edge connector, with the flap being large enough to cover all of the openings. The animal excrement may be screened from the litter by pulling upward on the uppermost layer and allowing the litter to pass through the openings as the flap drops down.

U.S. Pat. No. 4,505,226 relates to a litter cleaning animal litter box comprised of two substantially identical nestably stacked animal litter receptacles with aperture means at their bottoms sized to permit the passage of litter but retain solid waste. A false bottom to which the wetted litter adheres is fitted into each receptacle. The device has a retaining edge. The upper receptacle false bottom combination serves as a litter and waste holding means. The lower receptacle false bottom combination serves as a strained litter receiving means. The false bottom in the upper receptacle is removed along with the adhering wetted litter. The false bottom is mechanically worked in order to remove adhering litter for disposal. The upper receptacle is moved back and forth to make litter fall through receptacle's aperture into lower receptacle false bottom combination. Solid waste is retained in the upper receptacle and discarded. The cleaned false bottom is put into the cleaned receptacle. The receptacle false bottom combination now containing the cleaned litter is nestably stacked into the reassembled cleaned combination.

U.S. Pat. No. 5,488,929 relates to a disposable cat litter box liner formed of flexible sheet material, preferably paper, to assume a generally flat configuration prior to use, a box shaped configuration upon insertion into a cat litter box for holding litter, and a bag shaped configuration upon removal from litter box for dispensing litter. Liner includes arrangement of fold lines associated with end panels for permitting liner to be folded into a flat configuration prior to use. Liner includes a pair of elongate opposite top panels, which can include handles to facilitate lifting of the liner. When top panels are clasped together and liner lifted with cat litter in receptacle, the bottom panel collapses downward, the side panels collapse inward, and liner assumes bag shaped configuration for disposal of cat litter.

### SUMMARY OF THE INVENTION

The present invention relates to a flexible, semi-rigid or rigid plastic liner that is inserted into the bottom of an appropriate sized box or bin. The liner can also be made of cloth, polyethylene, fabric, fiber or fibrous material or any other durable material. The liner conforms to the bottom of the box or bin and becomes the base for all of the contents of the box or bin. It is an object of the present invention for the liner to have a series of heat seals or welds to provide strength and durability to lift the contents of the box or bin out by the liner. It is an object of the present invention for the liner and contents of the liner to be raised above the base of the box or bin but not out of the box or bin to allow a user to lift contents out of the box or bin while the contents are on the liner. It is an object of the present invention for the liner to be able to hold, when lifted, approximately 25-50 pounds. At either end of the liner is a handle that is used to pull out the contents of the box or liner. It is an object of the present invention for the liners to be sized accordingly and made to fit small, medium and large boxes/bins.

It is an object of the present invention for the liner to easily remove contents from the box or bin thus reducing back strain.

It is an object of the present invention for the liner to comprise a blend of plastic resins that include recycled plastic. It is an object of the present invention for the liner to be treated with a antimicrobial or antifungal treatment. It is an object of the present invention for the liner to be color coded. It is an object of the present invention for the liner to have printing on its surface. It is an object of the present invention for the liner to contain corporate logos to provide advertising brand messaging reinforcement. It is an object of the present invention for the liner to have a series of repeating corporate logos printed on the liner.

It is an object of the present invention for the liner to be used as an advertising vehicle to communicate messages, coupons or contests to customers.

It is an object of the present invention for the liner to provide a secondary protection for the contents of the box or bin, to protect the contents from dust, dirt, and minor spills/leaks from liquids.

It is an object of the present invention for the liner to be used after its initial use for secondary uses.

It is an object of the present invention for the liner's secondary uses to comprise: trunk liner, garment bag, table cloth, picnic mat, garden liner, storage bag, trash bags, kitty litter liner, or water drippage liner.

It is an object of the present invention for the liners to have a series of dotted lines printed on the liner approximately every 23 inches. After initial use, the consumer can cut along the dotted lines to form a bag with an opening that can be used as a trash bag for other packing materials.

It is an object of the present invention for other devices to be sold in conjunction with the liner to hold open the liner as contents are placed into the box or bin.

The present invention relates to a liner for a box or bin comprising a bottom part and two side parts. Each side part has a handle. The liner is inserted into the bottom of an appropriate size box or bin. The liner conforms to the bottom of the box or bin and becomes the base for all of the contents of the box or bin.

It is an object of the present invention for the bottom part to be rigid and the side parts to be flexible.

It is an object of the present invention for the bottom part and side parts of the liner to all be rigid.

It is an object of the present invention for the liner inserted into the bottom of the box to have a lip around the base to add structure and better lock in the contents of the box or bin.

The present invention relates to a liner for a box or bin comprising a bottom part and four side parts. Each side part has a handle. The liner is inserted into the bottom of an appropriate size box or bin. The liner conforms to the bottom of the box or bin and becomes the base for all of the contents of the box or bin.

It is an object of the present invention for the bottom part to be rigid and the side parts to be flexible.

It is an object of the present invention for the bottom part and side parts of the liner to all be rigid.

It is an object of the present invention to have multiple liners that can be used in the same box to separate contents and provide multiple layers.

It is an object of the present invention for the heat seals or welds to be repeated in the liner at a specific distance either vertically or horizontally.

It is an object of the present invention for the box to have flaps.

It is an object of the present invention for the liner to further comprise elastic material or rubber bands that hold the liner in place on the box flaps.

### BRIEF DESCRIPTION OF DRAWINGS

FIG. 1 is a side view of an embodiment of the box of the present invention having the liner inside the box.

FIG. 2 is a side view of an embodiment of the box of the present invention having the liner inside the box.

FIG. 3 is a top view of an embodiment of the liner of the present invention.

FIG. 4 is a side view of an embodiment of the box of the present invention having contents in the box resting on the liner where one side of the box is removed.

FIG. 5 shows a side view of an embodiment of the box of the present invention where a person is shown lifting the liner with the contents out of the box where one side of the box is removed.

FIG. 6 shows a top view of an embodiment of the liner of the present invention.

FIG. 7 shows a side view of a trash receptacle made of the cut liner of the present invention.

FIG. 8 shows a top view of an embodiment of the liner of the present invention being used as a trunk liner in an automobile.

FIG. 9 shows a side view of an embodiment of a liner of the present invention within a closed box.

FIG. 10 shows a side view of an embodiment of a liner of the present invention within an open box.

FIG. 11 shows a side view of an embodiment of a liner of the present invention.

FIG. 12 shows a side view of an embodiment of the box of the present invention having the liner inside the box.

FIG. 13 shows a side view of an embodiment of the present invention within an open box.

### DETAILED DESCRIPTION OF THE INVENTION

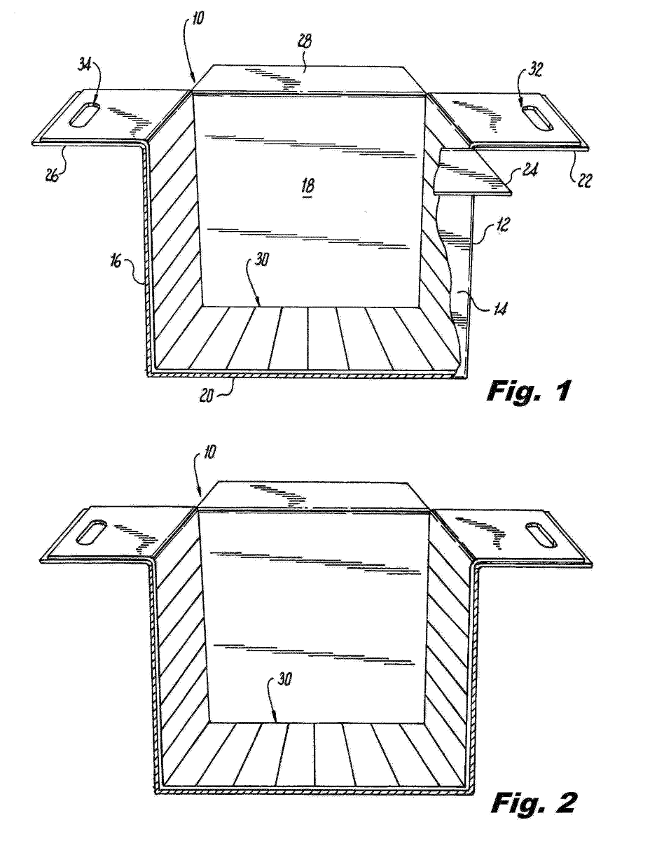

FIG. 1 shows a box 10 having four side walls, 12, 14, 16, and 18, a bottom wall 20 and four folded flaps 22, 24, 26 and 28. A liner 30 covers bottom wall 20 and side walls 12 and 16. The liner 30 also cover flaps 22 and 26 when the flaps are open. The liner contains handles 32 and 34.

FIG. 2 shows the box 10 with side wall 14 removed to better show the liner 30.

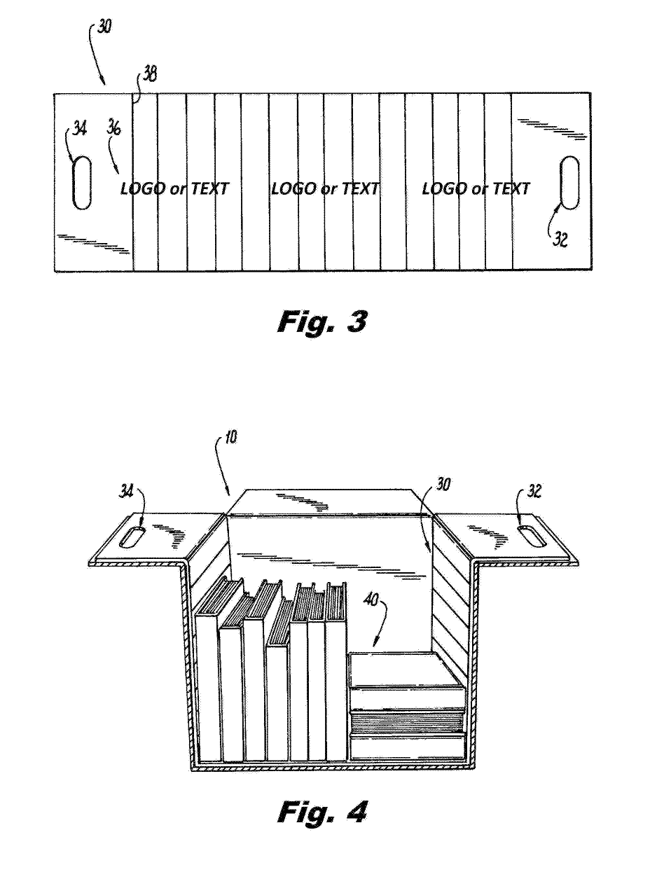

FIG. 3 shows the liner 30 having handles 32 and 34. The liner further comprises a printed logo or text 36 on the surface of the liner. The liner has heat sealed/welded seams 38 that provide strength and durability to the liner 30.

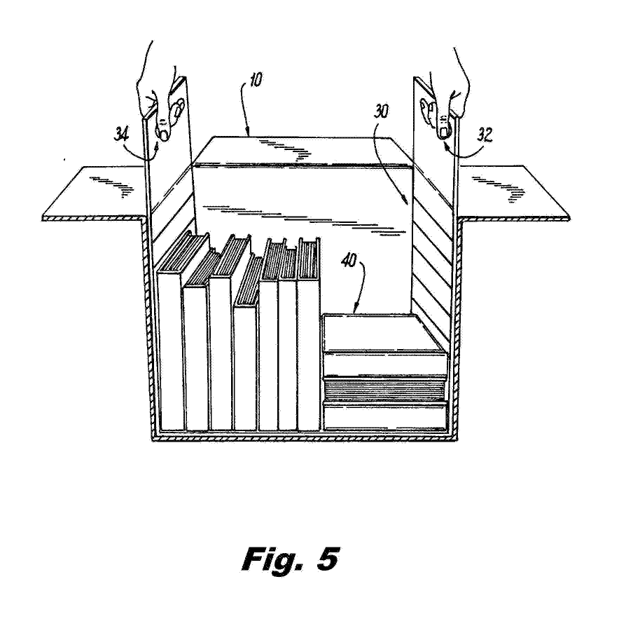

FIG. 4 shows box 10 having the liner 30 with handles 32 and 34. Contents 40 are located in box 10 on top of liner 30.

FIG. 5 shows box 10 having liner 30 with handles 32 and 34 being lifted by a person's hands. The liner has contents 40 within it.

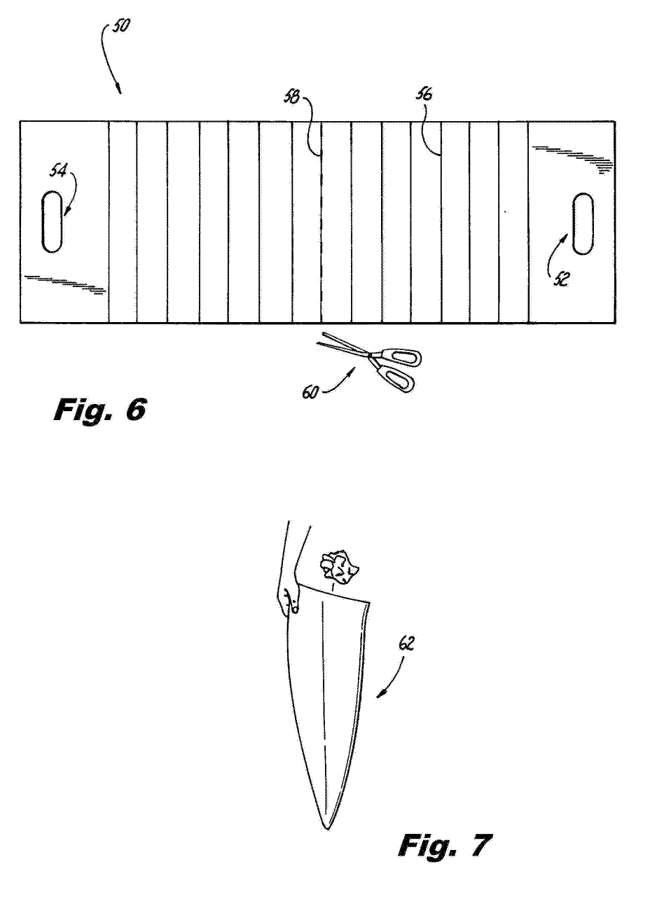

FIG. 6 shows liner 50 having handles 52 and 54. The liner 50 has heat sealed/welded seams 56 that provide strength and durability to the liner 50. The liner 50 has dotted printed lines 58 which is then cut with a cutting device 60 for forming two trash bags.

FIG. 7 shows trash bag 62 which was formed by cutting liner 50 in FIG. 6.

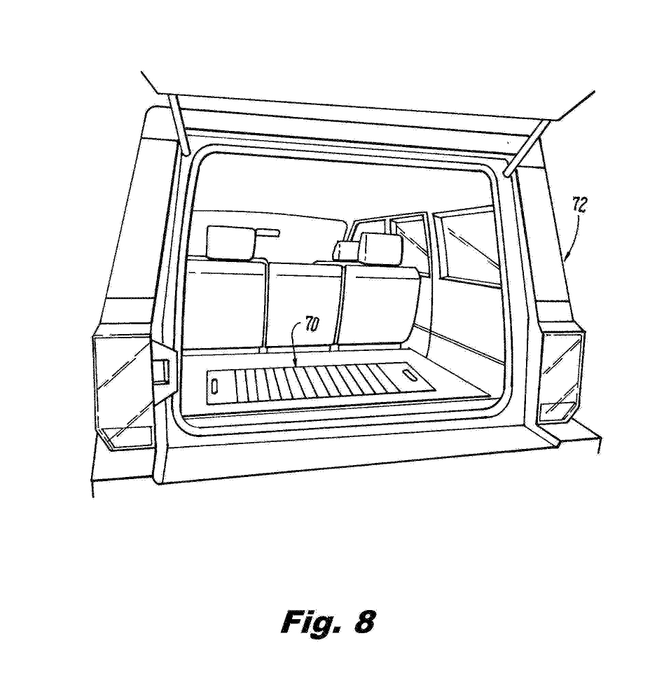

FIG. 8 shows liner 70 in the trunk of a car 72 being used as a trunk liner.

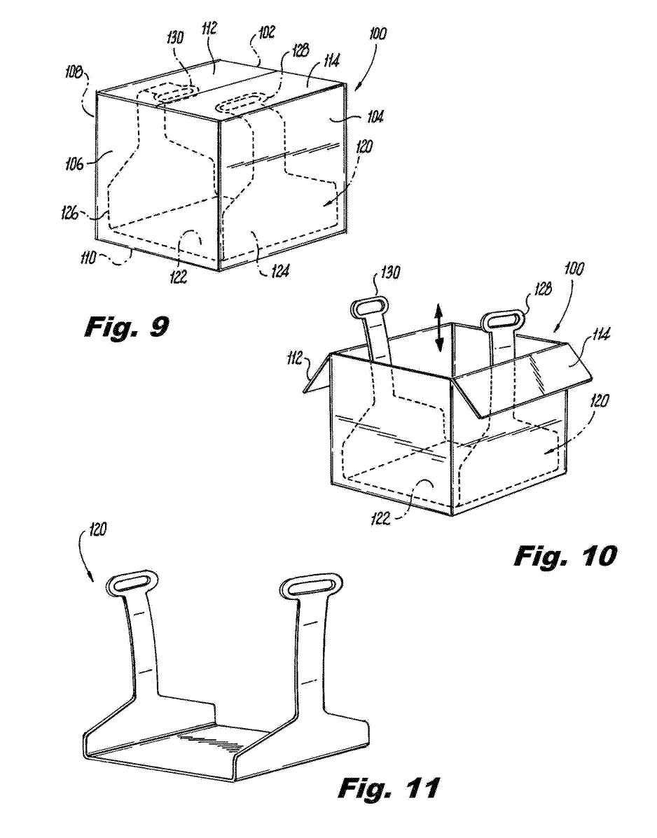

FIG. 9 shows a box 100 having four side walls 102, 104, 106 and 108, a bottom wall 110 and two top flaps 112 and 114. A liner 120 is comprised of a rigid bottom part 122 that is on top of bottom wall 110 and further has flexible side parts 124 and 126 which has handles 128 and 130 as part of the side parts.

FIG. 10 shows the box 100 of FIG. 9 having the flaps 112 and 114 open and having the handles 128 and 130 ready to be lifted by a user to lift any contents that are placed on the bottom part 122 of liner 120.

FIG. 11 shows the liner 120 outside of the box.

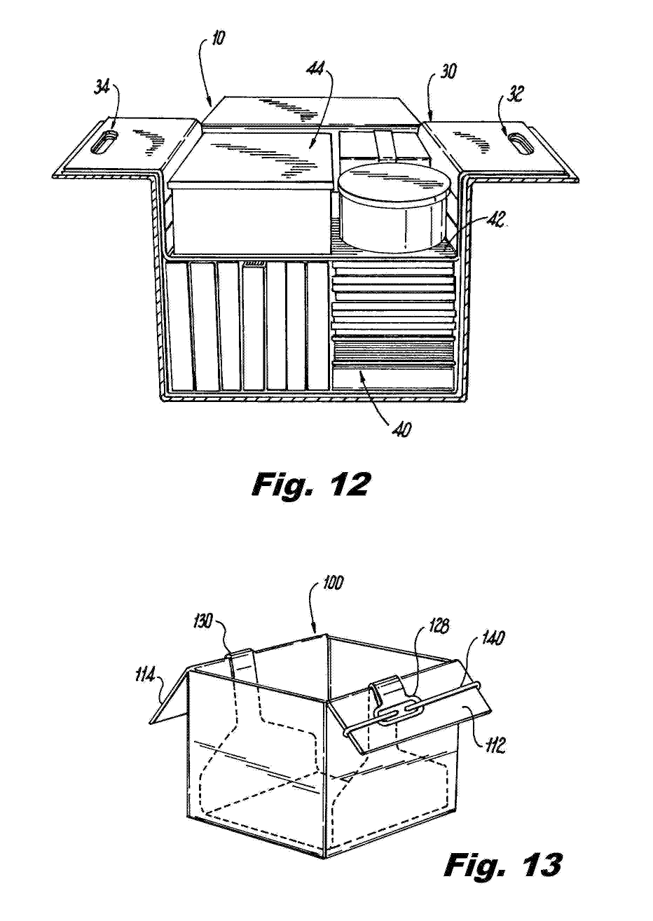

FIG. 12 shows the box and liner of FIG. 4, the liner 30 having a second layer 42 in which separate contents 44 can be laid upon.

FIG. 13 shows the box 100 of FIG. 9 having flaps 112 and 114 open and having the handles 128 and 130 that are attached to the flaps 112 and 114 by an elastic band 140.

1. A liner for a box or bin comprising:
a liner;
said liner inserted into bottom of an appropriate sized box or bin;
said liner conforms to said bottom of said box or bin and becomes base for all of contents of said box or bin;
said liner having at least two handles.

2. The liner of claim 1 wherein said liner is comprised of plastic, cloth, polyethylene, fabric, fiber or fibrous material.

3. The liner of claim 1 wherein said liner comprises a durable material.

4. The liner of claim 1 wherein said liner holds up to approximately 25-50 pounds when lifted.

5. The liner of claim 1 wherein said handles are located at either end of said liner.

6. The liner of claim 1 wherein said liner is sized accordingly, and made to fit small, medium and large boxes/bins.

7. The liner of claim 1 wherein said liner comprises a blend of plastic resins that include recycled plastic.

8. The liner of claim 1 wherein said liner is color coded.

9. The liner of claim 1 wherein said liner comprises printing on its surface.

10. The liner of claim 9 wherein said printing comprises corporate logos of a corresponding customer, to provide advertising brand messaging reinforcement.

11. The liner of claim 9 wherein said printing comprises a series of repeating corporate logos printed on said liner.

12. The liner of claim 1 wherein said liner is used as an advertising vehicle to communicate messages, coupons or contests to customers.

13. The liner of claim 1 wherein said liner provides a secondary protection for contents of said box or bin, to protect said contents from dust, dirt, and minor spills/leaks from liquids.

14. The liner of claim 1 wherein said liner is used after its initial use for secondary uses.

15. The liner of claim 14 wherein said liner's secondary uses comprise: trunk liner, garment bag, table cloth, picnic mat, garden liner, storage bag, trash bags, kitty litter liner, or water drippage liner.

16. The liner of claim 1 wherein said liner has a series of dotted lines printed on the liner.

17. The liner of claim 16 wherein said dotted lines are printed approximately every 23 inches.

18. The liner of claim 16 wherein after its initial use, a consumer cuts along said dotted lines to form a bag with an opening used as a trash bag for other packing materials.

19. The liner of claim 1 wherein other devices are used in conjunction with said liner to hold open said liner as contents are placed into said box or bin.

20. The liner of claim 1 wherein said box is a corrugated box.

21. The liner of claim 1 wherein said liner has a series of heat seals or welds.

22. The liner of claim 1 wherein said liner and contents of said liner are raised above said base of said box or bin but not out of said box or bin to allow a user to lift contents out of said box or bin while said contents are on said liner.

23. The liner of claim 1 wherein said liner is treated with an antimicrobial or antifungal treatment.

24. The liner of claim 1 wherein a liner has a lip which surrounds the base portion of said liner.

25. The liner of claim 1 wherein said liner comprises multiple layers.

26. A box having four side walls, a bottom wall and at least two folded flaps;
a liner covering said bottom wall and at least two of said side walls;
said liner comprising at least two handles.

27. The box of claim 26 wherein said liner further comprises an elastic band for attaching to said flaps.

28. The box of claim 26 wherein said liner further comprises a printed logo or text on surface of said liner.

29. The box of claim 26 wherein said liner has heat seals or welds.

30. The box of claim 26 wherein contents of said box are on top of said liner.

31. The box of claim 26 wherein said liner has dotted lines which are then cut with a cutting device to form two trash bags.

32. A liner for a box or bin comprising a bottom part;
two side parts;
said two side parts each having a handle;
said liner inserted into a bottom of an appropriate size box or bin;
said liner conforming to said bottom of said box or bin and becoming a base for all contents of said box or bin.

33. The liner of claim 32 wherein said bottom part is rigid and said two side parts are flexible.

34. The liner of claim 32 wherein said bottom part and said side parts are all rigid.
